(19) United States
(12) Patent Application Publication
(10) Pub. No.: US 2003/0006603 A1
(43) Pub. Date: Jan. 9, 2003

(54) Binder with whiteboard labelling member

(76) Inventor: Gary J. Pontecorvo, Flemington, NJ (US)

Correspondence Address: KENNETH P. GLYNN, ESQ., 24 Mine Street, Flemington, NJ, 08822-1598, US

(21) Appl. No.: 09/898,334

(22) Filed: Jul. 3, 2001

(51) Int. Cl. B42D 3/00

(52) U.S. Cl. 281/31

(57) ABSTRACT

The present invention is a binder for holding a plurality of sheets, which provides for repetitive changes to content identification without the need for substitute labeling. It includes a front member, having an outside surface and an inside surface; a back member, having an outside surface and an inside surface; a connecting mechanism for holding the front member and the back member together; a binding mechanism for temporarily binding a plurality of sheets between the front member and the back member; and, at least one whiteboard attached to at least one of the outside surface of the front member, the inside surface of the front member, the outside surface of the back member and the connecting mechanism. In some embodiments, there is a movable, protective, transparent cover located atop the whiteboard, and this cover is moveable with movement means selected from the group consisting of a hinge arrangement, a flap arrangement and a slide arrangement. The connecting mechanism may be at least one fastener adapted to temporarily hold the front member and the back member together or it may be a spine that is permanently connected to the front member and the back member. In an alternative embodiment, the whiteboard itself is removable and there may be a pocket, slot or other insert, or an attachment means. Such as a latch, a screw, hook and loop (Velcro), or other temporary holding means for temporarily securing the whiteboard to the binder.

### BACKGROUND OF THE INVENTION

1. Field of the Invention

The present invention is directed to binders for holding papers, documents, and sheets of flat material, such as paper and synthetics sheet materials. These binders may be loose-leaf binders, pocket binders, and clamp binders, metal strap fastener binders or any other type of binder. Such binders essentially have a front, a back and fastening means. In some cases the front and back are formed of a single cutting, casting molding or the like. In others, the binders are composite of cardboard or plastic, metal and cloth or vinyl. In some binders, the front and back are unconnected and are brought together as a unit when drilled or punched paper is bound. In yet others, the binders have distinct splines between the front and back sections. The critical feature of the present invention is that the binders have thereon at least one whiteboard for identifying the binder and/or its contents, to permit users to erase and change this information as the use of the binders change.

2. Information Disclosure Statement

Conventional binders are well known and have been for decades or longer. These binders come generally in two types of formats, namely, those which have fronts and backs which are permanently connected to one another, e.g., with a spline, and those which have separated front and back members which are assembled together at the time the contents are bound. In the first instance, the means for retaining or binding contents therein are by lockable/unlockable rings, by clamps which swing up and down or in and out, to open for inserting the contents, and to close for binding the contents by pressure, i.e., by squeezing the contents, or by metal fastener(s) which pass through the contents and are then fastened. Other types of binding structures are also available, such as collars and screws. Some have flexible fronts and backs and utilize holes and flat cotters to bind the sheet contents.

The binders which have separate fronts and backs typically have fasteners or flat cotters for securing the front and back and the contents simultaneously.

Methods of labeling binders includes writing on them, attaching glued labels thereto, and providing inserts or holders for typed or written labels. These labels are usually of awkward size for a typewriter or word processor and are time consuming to replace when contents change or volume number or other identifying information must be changed. Additionally, such systems may create difficulties for the user, as in cases where the user is not a good typist or word processor, or does have a typewriter or word processor and scissors available at the time the changes are desired.

The following patent is representative of the state of the art of binders with respect to visible content information:

U.S. Pat. No. 6,109,812 describes a binder with a spine window and removable insert. The insert is formed in the binder spine, and can be separate or part of a binder sheet. The insert is readily removable from the spine to be relabeled to indicate the materials in the binder. The insert can be pivotally mounted relative to the spine or it can be provided with openings that resiliently connect the insert to the rivets that secure the spine to the ring holder. This patent teaches that the insert either have another label placed over the old one each time a new identification is needed, or that a series of scored sections be rotated and labeled each time a new identification is needed. Unlike the present invention device, this prior art utilizes inserts, which are not reused and are not erasable. In fact, the lack of any suggestion of the use of whiteboards supports the patentability of the present invention.

Notwithstanding the aforesaid prior art, the present invention is neither taught nor rendered obvious thereby.

### SUMMARY OF THE INVENTION

The present invention is directed to a binder for holding a plurality of sheets, which offers the unique feature of repetitive changes to content identification without the need for substitute labeling. In general, the present invention binder includes a front member, having an outside surface and an inside surface; a back member, having an outside surface and an inside surface; a connecting mechanism for holding the front member and the back member together; a binding mechanism for temporarily binding a plurality of sheets between the front member and the back member; and, at least one whiteboard attached to at least one of the outside surface of the front member, the inside surface of the front member, the outside surface of the back member and the connecting mechanism. “Whiteboards” are known and are meant to devote flat surface components, which receive marker and similar writings and are readily erasable.

In some embodiments, there is a movable, protective, transparent cover located atop the whiteboard, and this cover is moveable with movement means selected from the group consisting of a hinge arrangement, a flap arrangement and a slide arrangement.

The connecting mechanism or connecting means may be at least one fastener adapted to temporarily hold the front member and the back member together or it may be a spine which is permanently connected to the front member and the back member.

The binding means of the binder may be any known binding means, including, but not limited to a plurality of openable-closeable rings, a lockable clamp, a metal fastener, posts and screws, etc. In some preferred embodiments, the binder is a three ring, loose-leaf binder.

In an alternative embodiment, the whiteboard itself is removable and there may be a pocket, slot or other insert, or an attachment means. Such as a latch, a screw, hook and loop (Velcro), or other temporary holding means for temporarily securing the whiteboard to the binder.

### BRIEF DESCRIPTION OF THE DRAWINGS

The present invention should be more fully understood when the specification herein is taken in conjunction with the drawings appended hereto wherein:

FIG. 1 illustrates a front view of a present invention binder and FIGS. 2 and 3 respectively show a side and bottom view thereof, wherein whiteboards are included on the front and spine members;

FIGS. 4 and 5 show a front oblique and a partial front blown apart view of an alternative embodiment present invention binder;

FIGS. 6 and 7 illustrate a side view and an inside open view of another alternative embodiment present invention binder.

### DETAILED DESCRIPTION OF THE PRESENT INVENTION

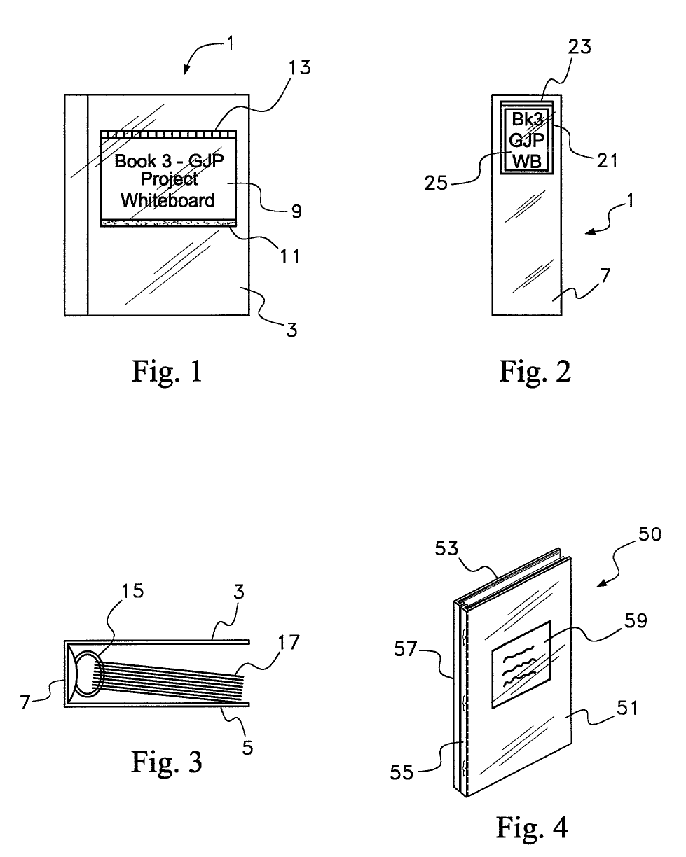

FIG. 1 illustrates a front view of a present invention binder shown generally as binder 1, and FIGS. 2 and 3, respectively, show a side and bottom view thereof. These figures are referred to herein collectively and identical elements are identically numbered.

There is a front member 3 and a similar back member 5 (not shown in detail) connected by spine 7. Front member 3 includes a permanently attached whiteboard 9 with a transparent cover 11 thereon Transparent cover 11 is a rigid clear plastic and has a securing element, such as reusable gum adhesive strip, at its bottom, and a hinge 13 at its top. A user would simply lift up cover 11 and erase whiteboard 9 to change the information presented thereon, as needed, e. g. when the pages inside are changed or the title or other information requires changing or editing. On spine 7, a second whiteboard 25 is permanently attached, and has a flexible plastic cover 21, with a hinge area 23 at its top, and close by, e.g., electrostatic attraction. As seen in FIG. 3, this binder 1 is a loose-leaf binder, such as a three ring binder, as illustrated by ring 15, holding pages 17, as shown.

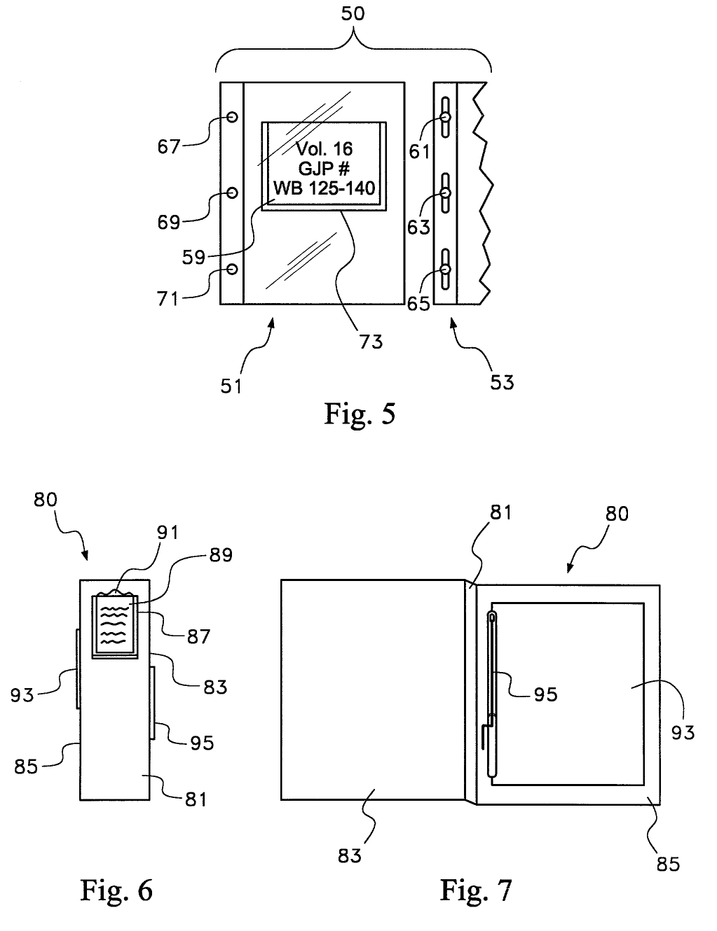

FIGS. 4 and 5 show a front oblique and a partial front blown apart view of an alternative embodiment present invention binder 50. It includes a front member 51, a back member 53 and a connecting means which includes fold over panels 55 and 57, and pins 61, 63 and 65, and corresponding holes 67, 69 and 71. These are used in a conventional fashion wherein the pins are first passed through three-hole drilled sheets of paper and then passed through holes 67, 69 and 71 in front member 51, so as to secure the paper and connect front member 51 and back member53. Front member 51 is transparent and has a whiteboard 59 connected to its inside surface by insertion into a clear plastic pocket 73. Alternatively, the whiteboard could be permanently connected to the inside surface of front member 51 in a hinged manner. Such a hinge could be a clear plastic strip, which acts as a vertical hinge so that a user open the whiteboard to erase and write on.

FIGS. 6 and 7 illustrate a side view and an inside open view of another alternative embodiment present invention binder 80. In this case, there is a spine 81, which connects front member 83 and back member 85. Spine 81 includes a pocket 87 made of clear plastic and contains therein a removable whiteboard 89, which has a pull tab 91 for easy removal and insertion. Similar pocket and whiteboard arrangements are included as components 93 and 95 on the back member 85 and the front member 83, as shown. In FIG. 7, it is shown that this binder is a latch or clip type binder wherein swing clip 95 is latched to secure and unlatched to remove or insert paper, such as paper 93. Other means for securing paper could be used in its stead.

Obviously, numerous modifications and variations of the present invention are possible in light of the above teachings. It is, therefore, understood that within the scope of the appended claims, the invention may be practiced otherwise than as specifically described herein. For example, the whiteboard components need not be rectangular in shape. They could be round, triangular or any other shape, to impart design, art or logo features, as desired. Likewise, the term “whiteboard” is used herein to denote a function and not a color. Thus, erasable whiteboard that is green or tan or other color would not exceed the scope of the present invention if it functioned as a whiteboard.

Also, the whiteboards with or without the protective clear cover may be manufactured at the time the binders are manufactured, or may be made separately and subsequently attached to binders. Thus, retrofitted whiteboards on binders are to be included within the scope of the present claims.

What is claimed is:

1. A binder for holding a plurality of sheets, which comprises:
(a.) a front member, having an outside surface and an inside surface;
(b.) a back member, having an outside surface and an inside surface;
(c.) connecting means for holding said front member and said back member together;
(d.) binding means for temporarily binding a plurality of sheets between said front member and said back member; and,
(e.) at least one whiteboard attached to at least one of said outside surface of said front member, said inside surface of said front member, said outside surface of said back member and said connecting means.

2. The binder of claim 1 wherein said connecting means is at least one fastener adapted to temporarily hold said front member and said back member together.

3. The binder of claim 2 wherein said at least one whiteboard is attached to said outside surface of said front member.

4. The binder of claim 1, which further includes a movable, protective, transparent cover located atop said at least one whiteboard.

5. The binder of claim 4 wherein said cover is moveable with movement means selected from the group consisting of a hinge arrangements, a flap arrangement and a slide arrangement.

6. The binder of claim 1 wherein said connecting means is a spine which is permanently connected to said front member and said back member.

7. The binder of claim 6 wherein said at least one whiteboard is attached to at least one of said spine and said outside surface of said front member.

8. The binder of claim 7 wherein said at least one whiteboard is two whiteboards and one is attached to said outside surface of said front member and one is attached to said spine.

9. The binder of claim 6 wherein further includes a movable, protective, transparent cover located atop said at least one whiteboard.

10. The binder of claim 9 wherein said cover is moveable, with movement means selected from the group consisting of a hinge arrangement, a flap arrangement and a slide arrangement.

11. The binder of claim 6 wherein said binding means is a plurality of openable-closeable rings.

12. The binder of claim 6 wherein said binding means is at least one lockable clamp.

13. The binder of claim 6 wherein said binding means is at least one metal fastener.

14. The binder of claim 11 wherein said binder is a three ring, loose leaf binder.

15. A binder for holding a plurality of sheets, which comprises:
(a) a front member, having an outside surface and an inside surface;
(b) a back member, having an outside surface and an inside surface;
(c) connecting means for holding said front member and said back member together;
(d) binding means for temporarily binding a plurality of sheets between said front member and said back member; and,
(e) at least one whiteboard removably connected to at least one of said outside surface of said front member, said inside surface of said front member, said outside surface of said back member and said connecting means.

16. The binder of claim 15 wherein said connecting means is at least one fastener adapted to temporarily hold said front member and said back member together.

17. The binder of claim 15 wherein said at least one whiteboard is located on said outside surface of said front member.

18. The binder of claim 15 wherein said at least one whiteboard is inserted into a protective, transparent cover.

19. The binder of claim 4 wherein said at least one whiteboard is inserted into a pocket located on at least one of said front member, said back member and said connecting means.

20. The binder of claim 15 wherein said connecting means is a spine which is permanently connected to said front member and said back member.
